(19) United States
(12) Patent Application Publication
(10) Pub. No.: US 2004/0009614 A1
(43) Pub. Date: Jan. 15, 2004

(54) Magnetic bead-based arrays

(76) Inventors: Chong H Ahn, Cincinnati, OH (US); Hyoung J Cho, Oviedo, FL (US); Jin-Woo Choi, Baton Rouge, LA (US)

Correspondence Address: Frost Brown Todd, 2200 PNC Center, 201 East Fifth Street, Cincinnati, OH, 45202, US

(21) Appl. No.: 10/276,099

(22) PCT Filed: May 11, 2001
(86) PCT No.: PCT/US01/15305

(51) Int. Cl. G01N 33/553

(52) U.S. Cl. 436/526; 422/58

(57) ABSTRACT

The present invention relates to magnetic particle separators using micromachined magnetic arrays and more particularly, to magnetic particle separators or manipulators using controlled magnetization on micromachined magnetic arrays for the separation of cells and other biological materials. The present invention also pertains to using such devices for the separation and analysis of biological materials for immunoassays, DNA sequencing, protein analysis, and biochemical detection applications. The present invention can also be viewed as a novel method for fabricating fully integrated permanent magnet components within any microelectromechanical system (“MEMS”) structures. The present invention also provides a magnetic particle separation and manipulation system for rapid separation and accurate manipulation of magnetic particles in two-dimensional electromagnetic arrays, which utilize high throughput biological analyses. A disposable cartridge can be produced in low cost using a low cost substrate such as plastic or other polymer, glass, or metal. Magnetic flux is generated by conventional or micromachined electromagnets a platform system consisting of magnetic flux sources, magnetic flux guidance, and a microprocessor control interface. By controlling direction of electric currents into inductors on the platform system, arbitrary magnetic poles can be generated on Permalloy structures of the cartridge to separate and manipulate magnetic particles. The magnetic particle separator and manipulator in the present invention can be easily combined with automated detection systems such as a fluorescent monitoring system.

This invention claims priority of U.S. Provisional Patent Appl. Ser. No. 60/204,214, filed May 12, 2000 and No. 60/209,051, filed Jun. 2, 2000, incorporated herein by reference.

### FIELD OF THE INVENTION

The present invention relates to magnetic particle separators using micromachined magnetic arrays and more particularly, to magnetic particle separators or manipulators using controlled magnetization on micromachined magnetic arrays for the separation of cells and other biological materials. The present invention also pertains to using such devices for the separation and analysis of biological materials for immunoassays, DNA sequencing, protein analysis and biochemical detection applications.

### BACKGROUND OF THE INVENTION

The use of micromachining techniques to fabricate separation systems in silicone. Silicone provides the practical benefit of enabling mass production of such systems. A number of established techniques developed by the microelectronics industry using micromachining exist and provide accepted approaches to miniaturization. Examples of the use of such micromachining techniques are found in U.S. Pat. Nos. 5,194,133, 5,132,012, 4,908,112, and 4,891,120 incorporated herein by reference in their entirety. Micromechanical devices and arrays of such devices may be mechanical, electromagnetic, electrostatic fluid or pneumatic in nature. Uses for such devices are readily apparent in the field. Such microdevices have been used for application in medicine, optics, microassembly, industrial process automation, analytical instruments, photonics and aerospace. In the field of micromechanical devices, miniaturization of analyzers provide an integrated system of pumps, flow ducks, flow valves, physical and chemical sensors, detectors, etc. produced on microscale structures or composites consisting of several microcomponents made from different materials.

Microfluidic biochemical analysis systems or lab-on-a-chip systems have a great interest in the area of biotechnology in terms of blood analysis, biochemical detection, drug discovery, and so forth.

Magnetic cell separation (MACS) is known to have high sensitivity, high throughput and high purity as well as increased recovery and viability of isolated cell populations compared to other cell separation method. (Andreas Thiel, Alexander Scheffold, and Andreas Radbruch, “Immunomagnetic cell sorting-pushing the limits.” Immunotechnology, 4, pp. 89-96, 1998). Thus, magnetic cell separation is particularly useful for isolation of rare cells from heterogeneous cell populations. Also it is technically simple and inexpensive. The cell suspension is mixed with a specific antibody that has been conjugated to iron-containing beads. The antibody-bead complex then binds to the cell marker, allowing cells to be sorted by running the cell suspension/antibody conjugate past electromagnets or magnets. Basically, this cell sorting technique can be used for separating all kinds of cells, which are identified by an antibody.

Recent studies in instruments for MACS enables continuous cell separation (Liping Su, Maciej Zborowski, Lee R. Moore, and Keffrey J. Chalmers, “Continuous, Flow-Through Immunomagnetic Cell sorting in a Quadrapole Field,” Cytometry, 33, pp. 469-475, 1998) and combination of video imaging (Sridhar Reddy, Lee R. Moore, Liping Su, Maciej Zborowski, and Keffrey J. Chalmers, “Determination of the magnetic susceptibility of labeled particles by video imaging,” Chem. Eng. Sci., Vol. 51, No. 6, pp. 947-956, 1996). Most of those works are intended to reduce response time of MACS by incorporating other sorting techniques such as bio-chemical detection and optical imaging.

By this reason, patterning of cell in microscale has been greatly demanded. Furthermore, total volume of sample required for analysis can be greatly reduced from the downsizing of instrument. Though conventional press forming or screen-printing can generate magnets in small dimension, such dimensions are still in millimeter scale. In contrast, magnets in microscale are required for confinement of cells, of which sizes range around tens of micrometers, within specific area to facilitate further optical and/or chemical analysis. As a result, direct biochemical/optical analyses combined with MACS are allowed on formed array patterns of labeled cells in addition to the advantages from conventional MACS using bulk magnets or electromagnets.

The present invention relates to a magnetic particle and/or bead separator and manipulator, and more particularly, to a magnetic particle and/or bead separator and manipulator which is based on a magnetic flux guiding disposable cartridge and a magnetic interconnection technique. Magnetic particles or beads are widely used as a carrier and/or a substrate of biological molecules for immunoassays, DNA sequencing, protein analysis and biochemical detection applications in recent biotechnology fields. Main difficulty in realizing such systems is to construct appropriate a magnetic particle separator and manipulator.

Prior to the present invention, macro-scale magnetic particle separators have been realized using permanent magnets. One such conventional magnetic particle separator utilizes an array of arbitrarily positioned, rectangular, rare earth permanent magnets. Generally, in order to achieve a magnetic field gradient that is sufficient to separate the particles, quadrupole or multipole permanent magnet arrangements are adopted and ferromagnetic wires are also introduced to generate the required magnetic gradient in an otherwise uniform magnetic field. When the magnetic particles suspended in a solution are subjected to the field, the magnetic forces produced by the magnets cause the particles to migrate and coalesce on to the magnetic poles or the ferromagnetic wires.

Micro-scale magnetic particle separators have also been realized using micromachined or miniaturized electromagnets to produce magnetic flux. However, difficulties in micro-scale integration of micromachined or miniaturized electromagnets with microfluidic channels make structure of micro-scale magnetic particle separators complex. Therefore, it is very difficult to precisely control magnetic separation of magnetic particles in micro-scale magnetic particle separators using small permanent magnets. For micro-scale magnetic particle separators using micromachined or miniaturized inductors, they produce Joule heat that increases temperature in suspension liquid and causes thermal convection in suspension liquid. In addition, most of micro-scale magnetic particle separators are for flow cell sorting, which means they can separate and manipulate magnetic particles with biological materials from flow suspension.

Existing magnetic particle separators can only separate or manipulate magnetic particles in fluid flow channel or column. Therefore, many problems are encountered when attempting to apply flow cell or column type magnetic particle separators to the area of high throughput biological analyses including DNA sequencing, immunoassay, protein analysis, and so forth.

### SUMMARY OF THE INVENTION

The present invention provides a new magnetic particle separation and manipulation methods for application to a high throughput biological analysis system by means of accurate control of magnetic particles in disposable two-dimensional array cartridge and magnetic flux generating platform that overcomes all of the above-referred problems.

The present invention also relates to a method of MACS and apparatus for MACS using micromachined magnets on the substrate. In the present invention, magnet arrays, e.g., thick CoNiMnP-based permanent magnet arrays, are provided with controlled direction of magnetization. Typically, the magnetic properties are controlled by external magnetic fields during formation. In one embodiment, the arrays are electroplated onto a substrate. Alternatively, channel filling can be used wherein a magnetic paste is prepared from magnetic particles and plastic binders. The magnetic paste is filled (e.g., by rubber squeegee) into channels, grooves, depressions or other cavities formed on at least one surface of a substrate. Magnetization is completed during or after curing along in-plane or out-of-plane axis. Due to the difference in curing condition between the photoresists and magnetic pastes, the photoresist molds can be removed, leaving the magnet array patterns on the substrate if necessary.

The present invention can also be viewed as a novel method for fabricating fully integrated permanent magnet components within any microelectromechanical system (“MEMS”) structures. In this regard, the present invention involves fabrication steps that are implemented with lithography, electroplating or channel filling techniques, although other suitable microfabrication techniques may be utilized.

The present invention provides a magnetic particle separation and manipulation system for rapid separation and accurate manipulation of magnetic particles in two-dimensional electromagnetic arrays, which utilize high throughput biological analyses. A disposable cartridge can be produced in low cost using a low cost substrate such as plastic or other polymer, glass, or metal. Magnetic flux is generated by conventional or micromachined electromagnets on non-disposable analysis platform. The platform system consists of magnetic flux sources, magnetic flux guidance, and a microprocessor control interface. Generally, the cartridge has permalloy structure that will work as magnetic poles. Preferably, the cartridge is a flexible plastic structure and is disposable. Magnetic separation takes place on the cartridge, which is placed on the top of the platform system. The cartridge is easily replaceable once used. Since there is no flow channel or column, design of the separation cartridge is very flexible for all sizes of magnetic particles. By controlling direction of electric currents into inductors on the platform system, arbitrary magnetic poles can be generated on permalloy structures of the cartridge to separate and manipulate magnetic particles. The magnetic particle separator and manipulator in the present invention can be easily combined with automated detection systems such as a fluorescent monitoring system.

### BRIEF DESCRIPTION OF THE DRAWINGS

This invention, as defined in the claims, can be better understood with reference to the following drawings. The drawings are not necessarily to scale, emphasis instead being placed upon clearly illustrating principles of the present invention.

FIG. 1 is a top plane view and a side view of fabricated magnet arrays for MACS;

FIGS. 2a-d show a step-by-step process of the fabrication of the magnets by electroplating;

FIGS. 3a-d show a step-by-step process of the fabrication of the magnets by channel filling;

FIG. 4. (a) is a side view of a chip for MACS composed of micromachined magnets on a substrate and a spacer. (b) is a side view of a chip for MACS composed of micromachined magnets on a substrate, a spacer with closed microchannel and fluidic access ports;

FIGS. 5a and b are schematic diagrams of illustrating the steps employed in MACS.

FIG. 6 is a schematic illustration of a microprocessor-controlled magnetic flux generating platform system and a disposable cartridge magnetic particle separator and manipulator.

FIG. 7 is a schematic illustration of an automated magnetic particle separator and manipulator.

FIGS. 8a-c are detailed illustration of a disposable magnetic particle separator and manipulator cartridge, a through magnetic flux guidance, and a platform control system.

FIGS. 9a and b are enlarged views illustrating a disposable cartridge.

FIG. 10 is a cross sectional illustration of a magnetic particle separator and manipulator using a disposable cartridge and platform control system.

FIG. 11. Micropipette array dispensing concept. Micropipette array dispenser is connected to a robotic arm control & pico- to micro-liter of fluid dispensing system.

FIG. 12. Magnetic field-assisted sample injection and dispensing concept. Pulsed or continuous magnetic fields can be applied to control number of magnetic beads. While the formation of a droplet at the tip of the pipette occurs, magnetic field will be applied between the tip and the spot to be dispensed. So, both the bead density of the aqueous solution and the applied magnetic field density will control the total number of magnetic beads in a formed droplet. The field density will be controlled in two steps: (a) a lower field for the formation of a droplet to control the number of the bead involved and (b) a higher field for assisting dispensing function without changing the format of the droplet while a fluidic pulsation motion occurs for dispensing the droplet on the testing spots.

FIG. 13. Magnetic field-assisted sample injection and dispensing concept.

FIG. 14. A schematic flow chart of a typical example of protein analysis using magnetic beads.

### DETAILED DESCRIPTION OF THE INVENTION

Definitions

As used herein, the term “binding assays” are assays that exploit the ability of certain molecules, herein referred to as “binding molecules”, to specifically bind target particles. Binding molecules such as antibodies, strands of poly- or oligonucleotides (DNA or RNA), proteins, synthetic polypeptides, chelators and molecular receptors, are capable of selectively binding to (“recognizing”) such “target particles” or molecules as poly- or oligonucleotides, enzymes and other proteins, polymers, metal ions, low molecular weight organic species such as toxins or drugs, cells, and fragments thereof.

Binding assays may be any compatible assay such as immunoassays, DNA hybridization assays, and receptor-based assays as known for diagnostic tests for a wide range of target molecules. Various types of binding assays have been devised that use radioactive, fluorescent, chemiluminescent, or enzymatic labels. Depending on the type of assay being performed, labeled binding molecules either bind to immobilized target molecules (“sandwich” assay), or compete with target molecules to bind to capture molecules (“competitive” assay). After removal of excess label, the amount of bound label is measured.

“Diamagnetic” as used herein, and as a first approximation, refers to materials that do not acquire magnetic properties even in the presence of a magnetic field, i.e., they have no appreciable magnetic susceptibility.

“Ferromagnetic” materials are strongly susceptible to magnetic fields and are capable of retaining magnetic properties when the field is removed. Ferromagnetism occurs only when unpaired electrons in the material are contained in a crystalline lattice thus permitting coupling of the unpaired electrons.

By “magnetization” of the particles of the invention is meant their magnetic moment per volume. Typically, magnetization is measured in Bohr magnetons per unit volume.

As used herein the terms “microbead,” “magnetic bead,” or “paramagnetic or superparamagnetic beads,” refer to any magnetically responsive particle having an exterior surface coated with a layer of material suitable for absorbing one or more binding molecules, such as antigens or antibodies, and that are suitable for binding to or being absorbed into biological particles, such as cells, viruses, oligonucleotides, proteins, etc. The selection of microbead is generally determined by the application, and particularly the size and quantity of particles being collected from the fluid sample. The selected bead can act as a tag for the target particle by binding particle specific agents to the bead exterior. In a preferred embodiment, the beads can be tags for biological particles by binding anti-bodies to the exterior surface of the bead. Typically, the antibodies are fixed to the beads by chemical coupling or by adsorption. In alternative embodiments, the tags can be specific for non-biological particles, by binding agents specific to non-biological characteristics of the target particle. In one example, positively charged ions can be bound to the particle surface for tagging the negatively charged particles within the fluid sample. Other such variations can be practiced without departing from the scope of the present invention.

Generally, to form paramagnetic or superparamagnetic beads, metal oxide particles are coated with polymers that are relatively stable in water. As used herein the term “metal oxide particle” refers to any oxide of a metal or metal alloy having paramagnetic or superparamagnetic properties. Suitable substances that may be incorporated as magnetizable materials, for example, include iron oxides such as magnetite, ferrites of manganese, cobalt, and nickel, hematite and various alloys. Magnetite is the preferred metal oxide. Frequently, metal salts are converted to metal oxides then either coated with a polymer or adsorbed into a bead comprising a thermoplastic polymer resin having reducing groups thereon. Magnetic particles may be formed by procedures shown in U.S. Pat. Nos. 5,834,121, 5,395,688, 5,356,713, 5,318,797, 5,283,079, 5,232,7892, 5,091,206, 4,965,007, 4,774,265, 4,770,183, 4,654,267, 4,554,088, 4,490,436, 4,336,173, and 4,421,660, each disclosure of which is incorporated herein by reference. Or, beads may be obtained commercially from available hydrophobic or hydrophilic beads that meet the starting requirements of size, sufficient stability of the polymeric coating, etc. Particles or beads have an average diameter of about 100 micrometers or less, preferably 1 to 10 micrometers.

By “polymer coating”, as it relates to the coating provided as the matrix of the invention, is meant a polymeric coating coated on the magnetic beads. Suitable polymers include polystyrenes, polyacrylamides, polyetherurethanes, polysulfones, fluoronated or chlorinated polymers such as polyvinyl chloride, polyethylenes and polypropylenes, polycarbonates and polyesters. Other polymers include polyolefins such as polybutadiene, polydichlorobutadiene, polyisoprene, polychloroprene, polyvinylidene halides, polyvinylidene carbonate, and polyfluorinated ethylenes. A number of copolymers, including styrene/butadiene, alpha-methyl styrene/dimethyl siloxane, or other polysiloxanes can be used. Included among these are polydimethyl siloxane, polyphenylmethyl siloxane, and polytrifluoropropylmethyl siloxane. Other alternatives include polyacrylonitriles or acrylonitrile-containing polymers such as poly alpha-acrylanitrile copolymers, alkyd or terpenoid resins, and polyalkylene polysulfonates.

“Superparamagnetic” materials are highly magnetically susceptible, becoming strongly magnetic when placed in a magnetic field, but like paramagnetic materials, rapidly lose their magnetism.

A “target molecule” can be any molecule capable of forming a complex with an oligonucleotide, including, but not limited to, peptides, proteins, enzymes, antibodies, hormones, glycoproteins, polymers, polysaccharides, nucleic acids, small organic compounds such as drugs, dyes, metabolites, cofactors, transition state analogs and toxins.

The term “substrate” is used herein to refer to any suitable material that is capable of being micromachined, e.g., silicon or silicon dioxide material such as quartz, fused silica or glass (borosilicates), plastics, polymers (including polyimides and the like), carbon-based materials, and ceramics (including aluminum oxides and the like).

As used herein, the term “detection means” refers to any means, structure or configuration that allows one to interrogate a sample within the sample processing compartment using analytical detection techniques well known in the art. Thus, a detection means includes one or more apertures, elongated apertures or grooves which communicate with the sample processing compartment and allow an external detection apparatus or device to be interfaced with the sample processing compartment to detect an analyte passing through the compartment.

A plurality of electrical “communication paths” capable of carrying and/or transmitting electric current can be arranged adjacent to the sample processing compartment such that the communication paths, in combination, form a circuit. As used herein, a communication path includes any conductive material that is capable of transmitting or receiving an electrical signal. In an exemplary embodiment, the conductive material is gold or copper.

The term “motive force” is used to refer to any means for inducing movement of a sample, and includes application of an electric potential, application of a pressure differential or any combination thereof.

The term “laser ablation” is used to refer to a machining process using a high-energy photon laser such as an excimer laser to ablate features in a suitable substrate. The excimer laser can be, for example, of the F2, ArF, KrCl, KrF, or XeCl type. In laser ablation, short pulses of intense ultraviolet light are absorbed in a thin surface layer of material within about 1 micron or less of the surface. Preferred pulse energies are greater than about 100 millijoules per square centimeter and pulse durations are shorter than about 1 microsecond. Under these conditions, the intense ultraviolet light photo-dissociates the chemical bonds in the material. Furthermore, the absorbed ultraviolet energy is concentrated in such a small volume of material that it rapidly heats the dissociated fragments and ejects them away from the surface of the material. Because these processes occur so quickly, there is no time for heat to propagate to the surrounding material. As a result, the surrounding region is not melted or otherwise damaged, and the perimeter of ablated features can replicate the shape of the incident optical beam with precision on the scale of about one micrometer.

Although laser ablation has been described herein using an excimer laser, it is to be understood that other ultraviolet light sources with substantially the same optical wavelength and energy density may be used to accomplish the ablation process. Preferably, the wavelength of such an ultraviolet light source will lie in the 150 nm to 400 nm range to allow high absorption in the substrate to be ablated. Furthermore, the energy density should be greater than about 100 millijoules per square centimeter with a pulse length shorter than about 1 microsecond to achieve rapid ejection of ablated material with essentially no heating of the surrounding remaining material. Laser ablation techniques are well known in the art.

The term “injection molding” is used to refer to a process for molding plastic or nonplastic ceramic shapes by injecting a measured quantity of a molten plastic or ceramic substrate into dies (or molds). In one embodiment of the present invention, devices may be produced using injection molding. More particularly, it is contemplated to form a mold or die of a device wherein excimer laser-ablation is used to define an original microstructure pattern in a suitable polymer substrate. The microstructure thus formed may then be coated by a very thin metal layer and electroplated (such as by galvano forming) with a metal such as nickel to provide a carrier. When the metal carrier is separated from the original polymer, a mold insert (or tooling) is provided having the negative structure of the polymer. Accordingly, multiple replicas of the ablated microstructure pattern may be made in suitable polymer or ceramic substrates using injection-molding techniques well known in the art.

The term “LIGA process” is used to refer to a process for fabricating microstructures having high aspect ratios and increased structural precision using synchrotron radiation lithography, galvanoforming, and plastic molding. In a LIGA process, radiation sensitive plastics are lithographically irradiated at high-energy radiation using a synchrotron source to create desired microstructures (such as channels, ports, apertures and micro-alignment means), thereby forming a primary template.

The term “chip” or “bio-chip” as used herein means a microfluidic system containing microdevice components on a substrate. The chip generally includes active and/or passive microvalves, fluidic components, electrical magnetic and/or pneumatic actuators, chambers, receptacles, diaphragms, detectors, sensors, ports, pumps, switches, conduits, filters, and related support systems.

The term “microfluidic” refers to a system or device having a network of chambers connected by channels, tubes or other interconnects in which the channels may act as conduits for fluids or gasses. Microfluidic systems are particularly well adapted for analyzing small sample sizes. Sample sizes are typically are on the order of nanoliters and even picoliters. Similar apparatus and methods of fabricating microfluidic devices are also taught and disclosed in U.S. Pat. Nos. 5,858,195, 5,126,022, 4,891,120, 4,908,112, 5,750,015, 5,580,523, 5,571,410, and 5,885,470, incorporated herein by reference.

“Microfluidic analytical systems” refer to systems for forming chemical, clinical, or environmental analysis of chemical and/or biological specimens. Such microfluidic systems are generally based on a chip. These chips are preferably based on a substrate for micromechanical systems. Substrates are generally fabricated using photolithography, wet chemical etching and other techniques similar to those employed in the semiconductor industry. Microfluidic systems generally provide for flow control and physical interactions between the samples and the supporting analytical structure. The microfluidic device generally provides conduits and chambers arranged to perform numerous specific analytical operations including mixing, dispensing, valving, reactions, detections, electrophoresis and the like.

The term “substrate” is used herein to refer to any material suitable for forming a microfluidic device, such as silicon, silicon dioxide material such as quartz, fused silica, glass (borosilicates), laser ablatable polymers (including polyimides and the like), and ceramics (including aluminum oxides and the like). One or more layers of material formed from a dimensionally stable support may form the substrate. Further, the substrate may comprise composite substrates such as laminates. A “laminate” refers to a composite material formed from several different bonded layers of same or different materials. In the case of polymeric substrates, the substrate materials may be rigid, semi-rigid, or non-rigid, opaque, semi-opaque or transparent, depending upon the use for which they are intended. For example, devices that include an optical or visual detection element will generally be fabricated, at least in part, from transparent materials to allow, or at least facilitate that detection. Examples of particularly preferred polymeric materials include, e.g., polymethylmethacrylate (PMMA), polydimethylsiloxanes (PDMS), polyurethane, polyimide, polyvinylchloride (PVC), polystyrene, polysulfone, polycarbonate, and the like. Preferably, these materials will be phenolic resins, epoxies, polyesters, thermoplastic materials, polysulfones, or polyimides and/or mixtures thereof.

In addition to constructing the substrate using conventional printed circuit board composites, alternative structures can be used. For example, for certain applications the use of plastic films, metals, glasses, ceramics, injection molded plastics, polyastomeric layers, ferromagnetic layers, sacrificial photo resist layers, shaped memory metal layers, optic guiding layers, polymer based light displays or other suitable materials may be used. These may be bound with the substrate to form the system with or without an adhesive bonding layer.

In general, microfluidic devices can be fabricated out of any material that has the necessary characteristics of chemical compatibility and mechanical strength. One exemplary material is silicon since a wide range of advanced microfabrication and micromachining techniques have been developed for it and are well known in the art. Additionally, microfluidic devices can be produced directly in electrically insulating materials. The most widely used processes include isotropic wet chemical etching of glass or silica and molding of plastics. In another embodiment, the microfluidic devices can be produced as a hybrid assembly consisting of three layers—(1) a substrate, (2) a middle layer that forms the channel and/or chamber walls and whose height defines the wall height generally joined or bonded to the substrate and (3) a top layer generally joined or bonded to the top of the channels that forms a cover for the channels. In one exemplary method, the channels are defined by photolithographic techniques and etching away the material from around the channel walls produces a freestanding thin walled channel structure. Freestanding structures can be made to have very thin or very thick walls in relation to the channel width and height. The walls, as well as the top and bottom of a channel can all be of different thickness and can be made of the same material or of different materials or a combination of materials such as a combination of glass and silicon. Sealed channels or chambers can be made entirely from silicon glass and/or plastic substrates.

It should be noted that throughout the description the terms “channel” and “micro-channel” refer to structures for guiding and constraining gasses or fluids and gas or fluid flow and also include reservoir structures associates with micro-channels and will be used synonymously and interchangeably unless the text declares otherwise.

Micromachined Magnetic Arrays

The present invention also relates to a method of MACS and apparatus for MACS using micromachined magnets on the substrate. In the present invention, magnet arrays, e.g., thick CoNiMnP-based permanent magnet arrays, are provided with controlled direction of magnetization. Typically, the magnetic properties are controlled by external magnetic fields during formation. In one embodiment, the arrays are electroplated onto a substrate. Alternatively, channel filling can be used wherein a magnetic paste is prepared from magnetic particles and plastic binders. The magnetic paste is filled (e.g., by rubber squeegee) into channels, grooves, depressions or other cavities formed on at least one surface of a substrate. Magnetization is completed during or after curing along in-plane or out-of-plane axis. Due to the difference in curing condition between the photoresists and magnetic pastes, the photoresist molds can be removed, leaving the magnet array patterns on the substrate if necessary.

The present invention can also be viewed as a novel method for fabricating fully integrated permanent magnet components within any microelectromechanical system (“MEMS”) structures. In this regard, the present invention involves fabrication steps that are implemented with lithography, electroplating or channel filling techniques, although other suitable microfabrication techniques may be utilized.

In one embodiment, the device is manufactured by the method comprising the steps of (a) providing a suitable substrate 50 and (b) applying a suitable array of permanent magnets 52 to at least one surface of the substrate 50. In another embodiment, the array is pattern molded by photolithography. In another embodiment, the array fabricated by electroplating magnetic alloys. In yet another embodiment, the array is fabricated by channel filling a mixture of magnetic particles and resin in an array pattern while applying an external magnetic field to the substrate 50. The magnet arrays can be fabricated in one or more various shapes and sizes on any suitable substrate using micromachining and electroplating and/or channel filling techniques.

In the present invention, the magnet arrays are typically integrated to form a chip for MACS. A chip generally includes at least one magnet or array 52 on at least one surface of a substrate 50. In one embodiment, such a chip includes another separate substrate defining a channel or reservoir chamber accommodating colloidal suspensions of cells. In another embodiment, the chip will further include at least one port for introduction of fluid into the chamber. In another embodiment, the chip will further include at least one input port and at least one output port for continuous fluidic operation. In this embodiment, the present invention provides a method of cell separation or sorting comprising the following operation steps; (a) inflow of a mixture of magnetically labeled and unlabelled cells into a defined chamber; (b) immobilization of magnetically labeled cells; and (c) washing and removal of unlabeled cell (e.g., with a buffer solution or other wash fluid).

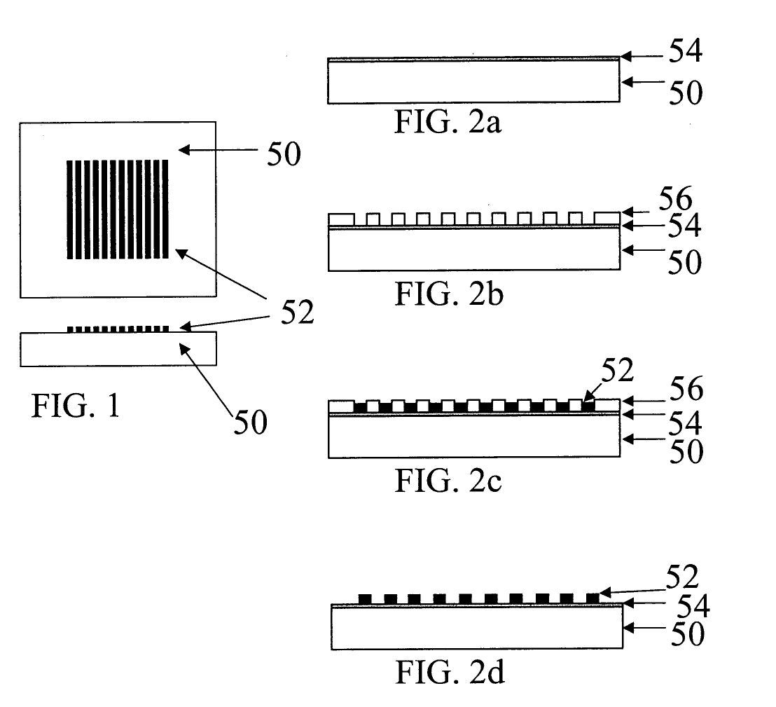

With reference to the drawings wherein like numerals represent corresponding parts corresponding parts throughout the several views, FIG. 1 illustrates a top plane view and a side view of the micromachined magnets 52 on a substrate 50. Because magnet array 52 is fabricated using a batch process of photolithography and electroplating or channel filling techniques, they are capable of being mass-produced economically and are particularly suited for MACS in microscale.

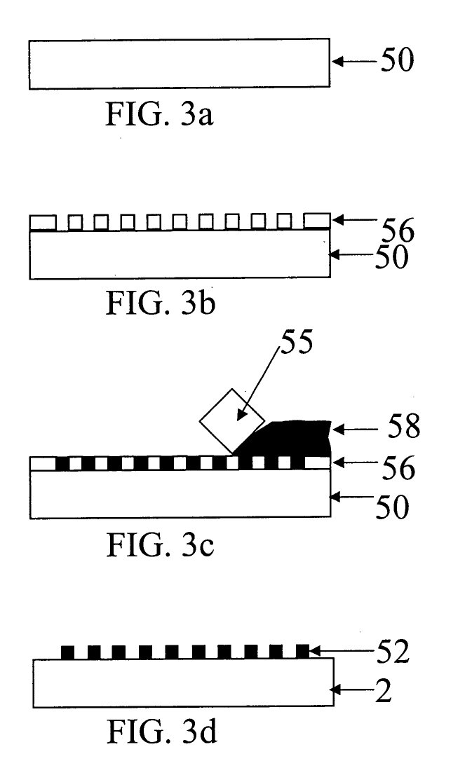

A method of fabricating the magnet arrays in accordance with the present invention is described by reference to FIGS. 2 and 3. When electroplating is used as shown in FIG. 2, the fabrication process begins with a substrate base 50, generally comprising a silicon, glass, plastic or other polymer wafer for the, on which is deposited a seed layer 54. In one embodiment, the seed layer 54 consists of a metal layer comprising at least one metal selected from the group consisting of copper, nickel, gold, silver, platinum and alloys thereof in a thickness of from about 10 to about 25000 angstroms, preferably from about 100 to about 10000 angstroms, and more preferably from about 1000 to about 5000 angstroms.

In another embodiment, the seed layer 54 consists of an at least one metal adhesion layer selected from the group consisting of chromium, titanium, and alloys thereof in a thickness from about 10 to about 5000 angstroms, preferably from about 500 to about 1000 angstroms, and more preferably from about 100 to about 500 angstroms, wherein the adhesion layer is deposited on at least one surface of the substrate

In another embodiment, the seed layer 54 consists of a first metal layer or adhesion layer selected from the group consisting of chromium, titanium, and alloys thereof in a thickness from about 10 to about 5000 angstroms, preferably from about 500 to about 1000 angstroms, and more preferably from about 100 to about 500 angstroms, wherein the adhesion layer is deposited on at least one surface of the substrate and an at least one second metal layer or final seed layer is thereon deposited on top of the first metal layer wherein the second seed layer is a metal selected from the group consisting of gold, copper, nickel, gold, silver, platinum and alloys thereof in a thickness from about 10 to about 25000 angstroms, preferably from about 100 to about 10000 angstroms, and more preferably from about 1000 to about 5000 angstroms.

Thereafter, one or more coats of photoresist 56 are applied onto the substrate 50 to create a photoresist layer having a thickness of from about 0.01 microns to about 500 microns, preferably from about 0.1 microns to about 200 microns, more preferably from about 1 microns to about 100 microns, and most preferably from about 10 microns to about 50 microns. During photolithography, selectively UV-exposed photoresist is removed with a developer to selectively form at least one channel or opened area of photoresist 56, which is then used as an at least one electroplating mold. The at least one open area is then electroplated with hard magnetic alloy. In the finished array device, the magnet strips 52 has a height of from about 0.01 microns to about 500 microns, preferably from about 0.1 microns to about 200 microns, more preferably from about 1 microns to about 100 microns, and most preferably from about 10 microns to about 50 microns; a width of from about 0.01 microns to about 500 microns, preferably from about 0.1 microns to about 200 microns, more preferably from about 1 microns to about 100 microns, and most preferably from about 10 microns to about 50 microns; and the gap between magnets is from about 0.01 microns to about 500 microns, preferably from about 0.1 microns to about 200 microns, more preferably from about 1 microns to about 100 microns, and most preferably from about 10 microns to about 50 microns.

The direction of magnetization in the magnet array is controlled by external magnetic field during electroplating along in-plane or out-of-plane axis. In one embodiment, the composition of magnet arrays is controlled to have (a) from about 50 to about 97% Co, preferably from about 60 to about 95% Co, and more preferably from about 70 to about 90% Co; (b) from about 0 to about 40% Ni, preferably from about 0 to about 30% Ni, and more preferably from about 0 to about 20% Ni; (c) from about 0 to about 10.0% P, preferably from about 0 to about 5.0% P, and more preferably from about 0 to about 3.0% P; and (d) from about 0 to about 4% Mn, preferably from about 0 to about 2% Mn, and more preferably from about 0 to about 1.2% Mn in electroplated structures. After magnetization, the hard magnetic arrays of Co—Ni—Mn—P alloys consist of permanent magnet arrays 52. Generally, the optimized processing conditions with external magnetic fields during electroplating improve the coercivity and the retentivity of the magnets by more than about 200% and about 350% respectively, comparing with those electroplated without external magnetic fields.

When channel filling is used as shown in FIG. 3, a magnetic paste is used to form the magnetic array 52. The magnetic paste is generally prepared from magnetic particles and plastic binders. The plastic binders can be any suitable polymeric binder, including but not limited to, epoxy resins, UV-sensitive epoxy resins, room temperature curable silicone rubbers, polyvinyl alcohol or cyanoacrylate in powder or dissolved liquid forms. The plastic binder can be either a thermoplastic or thermosetting resin, such resins are widely known in industry. The viscosity is controlled by mixing ratio of magnetic particles and binders dissolved in solvent such as toluene, methanol, ethanol, butanol, isopropanol, methyl ethyl ketone or gamma-butyloractone. Preferably, ball milling or high speed milling machine is used to mix the particle and the resin. In the typical formulation, the viscosity of the paste is in the range of from about 10 to about 1000 cP. Preferably, either Ba-ferrite (BaFe₁₂O₁₉), Sr-ferrite (SrFe₁₂O₁₉) based powder or rare earth magnet powder of Nd—Fe—B (Nd₁₋₃Fe₁₂₋₁₄B) or Sm—Co (SmCo₃₋₉) based alloy or combinations and mixtures thereof are used as the magnetic material. Preferably, the material is dispersed within a liquid or dissolved epoxy resin as binding material. In using Ba-ferrite (BaFe₁₂O₁₉), Sr-ferrite (SrFe₁₂O₁₉) based magnetic particles, the particles are generally less than about 500 microns in size, preferably less than about 100 microns in size, more preferably less than about 10 microns in size. In using rare earth magnet powders of Nd—Fe—B (Nd₁₋₃Fe₁₂₋₁₄B) or Sm—Co (SmCo₃₋₉) based alloy magnetic particles, the particles are generally less than about 1000 microns in size, preferably less than about 500 microns in size, more preferably less than about 100 microns in size.

The magnetic paste is generally prepared to comprise a magnetic powder in the range of from about 5 to about 95 volume %, preferably from about 10 to about 80 volume %, more preferably from about 15 to about 75 volume %, and most preferably from about 20 to about 70 volume % based on the total paste composition volume.

A squeegee 55, such as a rubber squeegee, fills magnetic paste 52 into channels, grooves, depressions, voids, channels, or other cavities on the substrate, generally. The channels are generally formed by photolithography as described above. The device is preferably cured at a temperature from about 25 to about 250° C., preferably from about 45 to about 180° C., and more preferably from about 60 to about 120° C. Magnetization is completed during or after curing along in-plane or out-of-plane axis by methods well known in the art. Due to the difference in curing condition between the photoresist and magnetic paste, the photoresist molds 56 can be removed, leaving the magnet array 52 patterned on the substrate. Optionally, additional curing under higher temperature can be done to achieve higher density magnets.

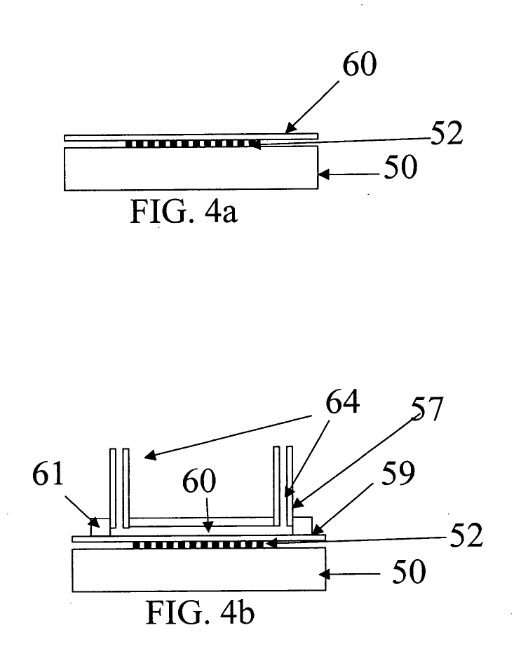

FIG. 4a shows a constructed chip for MACS permanent magnet array 52 on a substrate 50 and a spacer 60. Magnetically labeled biological particles are placed on the spacer 60 and thereafter attracted and captured toward the patterned magnet arrays 52. Upon interaction of the array with a mixture of magnetically labeled biological particles, non-labeled biological particles can be removed, e.g., by washing with a buffer or other wash solution. Generally, biological particles are magnetically labeled using microbeads.

Likewise, FIG. 4b shows a similar chip composed of micromachined magnets 52 on a substrate 50, a spacer 60 with closed microchannel 59 defined by the substrate 50 and spacer 60. In one embodiment, the substrates consist of one or more transparent or semi-transparent materials selected from the group consisting of glass, silicon and plastic. In one embodiment, the chip consists of a layer of substrate 50; a layer of magnets 52; a layer of spacer 60; a microfluidic channel 59 closed in by a layer a second substrate 61. In another embodiment, the microfluidic channel 59 has one or more fluidic access ports 64 from the bottom to the top. This device allows continuous separation of biological particles by the sequence of (a) inflow of a mixture of biological particles through an access port 64 (b) immobilization of magnetically labeled biological particles within the microfluidic channel 59 by magnets 52 (c) and the wash-out and removal of unlabeled biological particles with buffer solution.

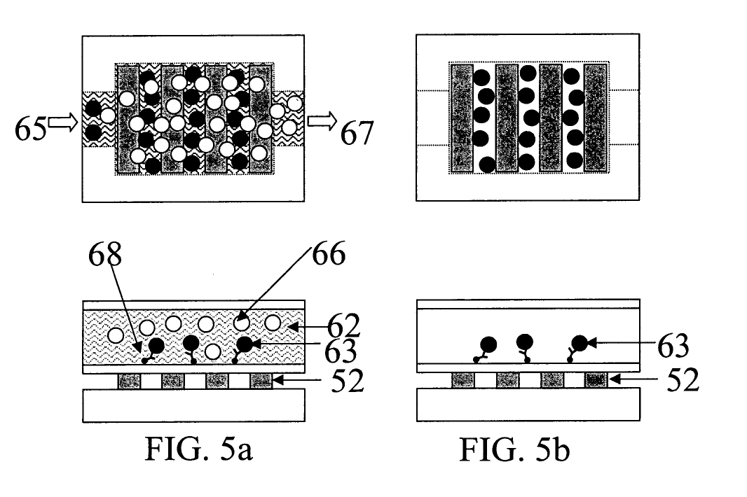

FIGS. 5a and 5b are schematic illustrations showing the operation of MACS on this invention. As shown in FIG. 2a, the mixture of biological particles in buffer solution 62 are introduced through an inlet port 65 and placed on top of micromachined magnet arrays 52 to immobilize magnetically labeled biological particles 63 for a specific time period. Then, the non-magnetically labeled biological particles 66 are substantially washed out of the chip through outlet 67 using buffer solution or other wash fluid and thereafter substantially only magnetically labeled biological particles 63 remain in patterned shapes given by magnetic arrays. Most importantly, biological particle separation and patterning are achieved using this invention for further chemical or optical analysis in one step.

Magnetic Particle Separator

In this invention, a method and device for magnetic particle separation and manipulation are provided for separation of biological cells or biomolecules and for application to clinical diagnostics, protein analysis, and DNA sequencing. By separating the magnetic particles, it is possible to sort and separate the target biological cells or biomolecules, which are attached to the magnetic particles, on an array cartridge. In one embodiment, the cartridge is disposable.

Paramagnetic particles have one very critical property not found in any other “separation technique”, namely that one can enrich for the ligand of choice and whatever is bound to it at any time during the chain of manipulations. This characteristic allows protocols that optimize speed of reaction, multiple step reactions and quantitation while maintaining the best aspects of DNA or protein microchips, with their indexed reaction positions and use of small sample volume. There are other benefits to the use of paramagnetic particles manipulated by microscopic electromagnets too numerous to mention, but what is clear is that this technology has significant advantages compared to present schemes.

The present invention also provides a magnetic particle separation and manipulation system for rapid separation and accurate manipulation of magnetic particles in two-dimensional arrays, which utilize high throughput biological analyses. A disposable cartridge can be produced in low cost using a low cost substrate such as plastic or other polymer, glass, or metal. Magnetic flux is generated by conventional or micromachined electromagnets on non-disposable analysis platform. The platform system consists of magnetic flux sources, magnetic flux guidance, and a microprocessor control interface. Generally, the cartridge has permalloy structure that will work as magnetic poles. Preferably, the cartridge is a flexible plastic structure and is disposable. Magnetic separation takes place on the cartridge, which is placed on the top of the platform system. The cartridge is easily replaceable once used. Since there is no flow channel or column, design of the separation cartridge is very flexible for all sizes of magnetic particles. By controlling direction of electric currents into inductors on the platform system, arbitrary magnetic poles can be generated on permalloy structures of the cartridge to separate and manipulate magnetic particles. The magnetic particle separator and manipulator in the present invention can be easily combined with automated detection systems such as a fluorescent monitoring system.

Application of the present invention is high throughput biological analysis system using magnetic particles as a carrier and a substrate of biological materials such as DNA probes, antibodies, cells, and so forth.

Although the present invention has been discussed with respect to the preferred and alternative embodiments, it will be apparent to those skilled in the art that the present invention is not limited to these embodiments. For example, the process steps described above may be varied to alter certain characteristics of the magnetic particle separator and manipulator system. Therefore, a person of ordinary skill in the art will understand that variations and modifications of the present invention are within the spirit and scope of the present invention.

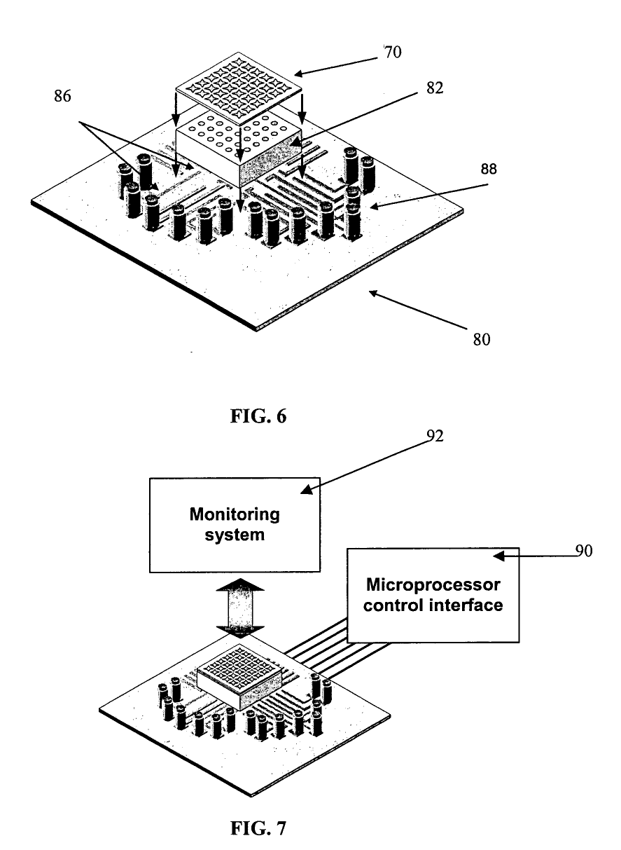

The device is mainly composed of a platform control system 80 and a disposable cartridge 70 as illustrated in FIG. 6. Typically, the platform control system 80 consists of microscale electromagnets or permanent magnets, patterned/aligned soft magnetic material for magnetic flux guiding structures, and interface to microprocessor control system on substrate.

The whole system will be connected to microprocessor control interface 90 and will be mounted under an optical monitoring system 92 for biological analysis as illustrated in FIG. 7.

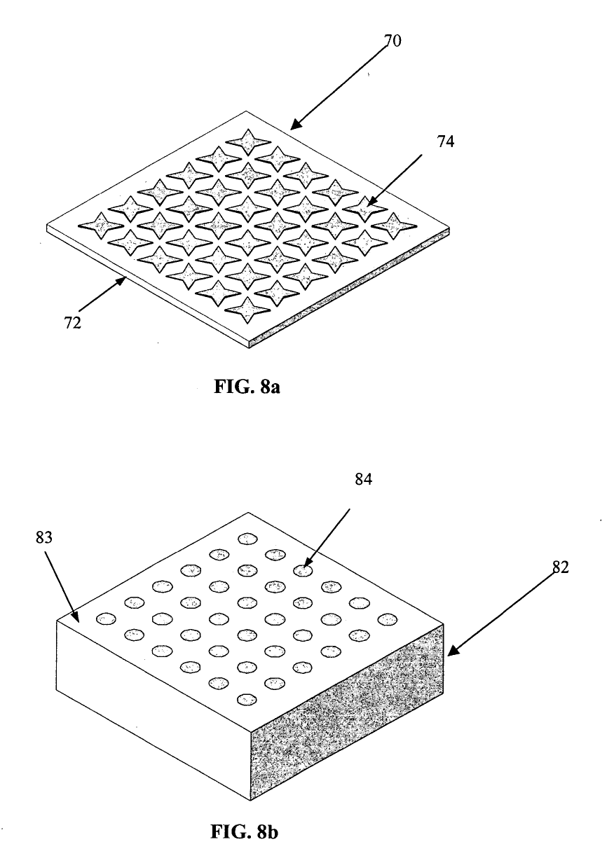

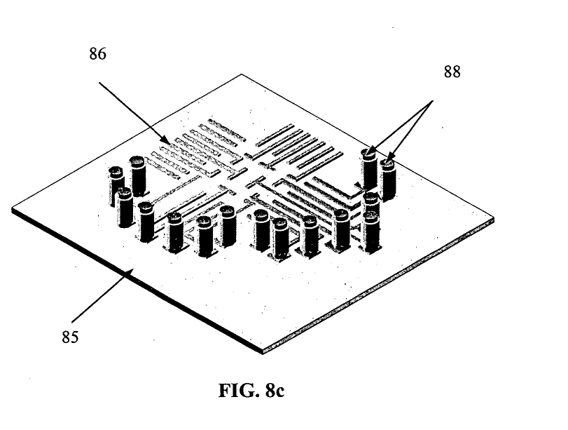

FIG. 8a illustrates a disposable cartridge 70, which will be microfabricated on a substrate 72, typically thin glass, plastic, or other polymer. Desired permalloy structures 74 are then deposited on the surface of at least one face of the substrate 72. Patterning by photolithography and electroplating as well as any other suitable microfabrication techniques as well known in the art are typically used to manufacture the permalloy structures. Magnetic force simulations and the size of magnetic particles determine shapes and dimensions of permalloy structures. In one embodiment, the Permalloy structures are star-shaped quadrapoles. Generally, there is no cleaning step required after magnetic separation and manipulation for biological analyses for a disposable cartridge since it will be replaced with a new one after use.

The platform control system consists of two basic components; one is through-hole permalloy (or similar material) magnetic flux guidance which will be fabricated by UV-LIGA or LIGA process and electroplating technique, and the other part is one or more inductors, preferably microprocessor controlled.

FIG. 8b illustrates a through-hole magnetic flux guidance device. The device is microfabricated using LIGA or UV-LIGA process and electroplating technique.

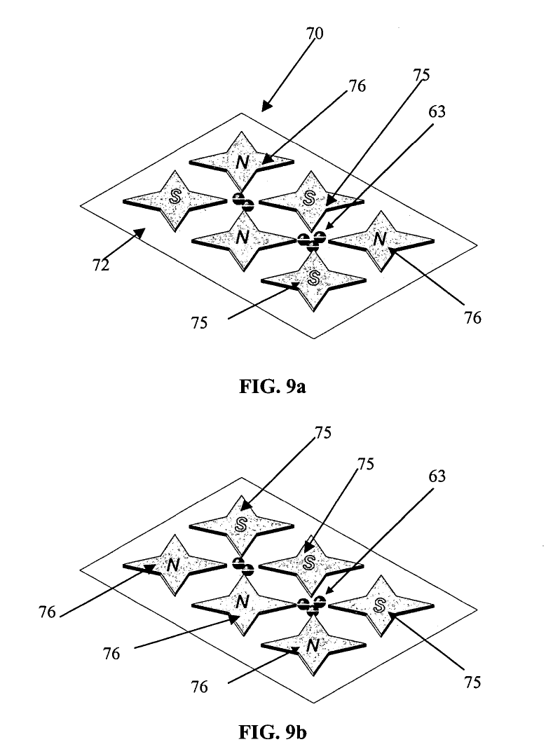

FIG. 8c illustrates a microprocessor controlled inductor and Permalloy magnetic flux guidance. Each inductor 88 works independently and can produce magnetic flux at any given point as directed by a programmed controller. The inductors 88 generate magnetic flux and the generated magnetic flux passes along the magnetic guidance to the star-shaped quadrapoles 74 on a cartridge 70. By controlling on/off status of the inductors 88 or the direction of the electric current into the inductors, the quadrupole structures 74 can act n-pole 76 or s-pole 75. Then, the magnetic particles 63 are collected at each edge of the quadrapoles 74 as illustrated in FIGS. 9a and b.

Magnetic fields can be applied either way in FIGS. 9a and b for magnetic beads separation. Magnetic beads are separated in accordance with applied magnetic fields or flux through magnetic flux guidances (poles) 75 and 76 on the substrate.

As will be understood by those in the art, the magnetic flux guidances do not need to be ‘four-pointed’ quadrapoles but can be any shape, including about 2 or about 8 or more pointed shapes that allows for the direction of the flux to be controlled. However, I can say that the size will be in the range of a few microns to a few millimeters. Any soft magnetic materials and/or ferromagnetic materials can be used for the magnetic flux guidances such as NiFe alloy, Ni, or Ni-based alloy. Preferably, the guidances are made from NiFe or Permalloy due to their high magnetic permeability. Current into the electromagnets will typically be in the range of from about 10 mA to about 500 mA.

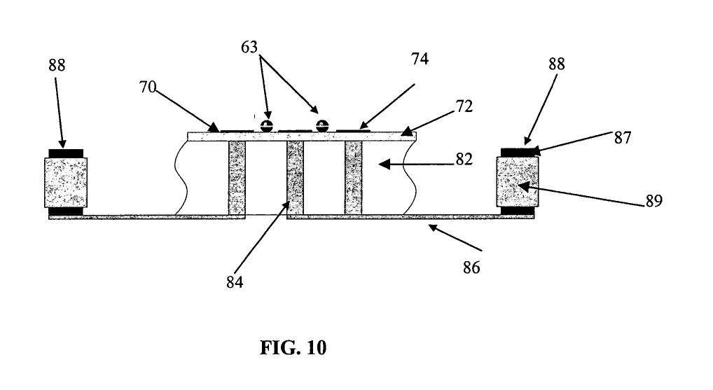

FIG. 10 shows the sources of magnetic field or flux are microscale electromagnets 87-89 which are controlled by electric current applied into coils 89. The electric current is fully or partially controlled by microprocessor based control interface system 90 to turn on and off the electromagnets so the magnetic field or flux is turned on and off. The generated magnetic field or flux is guided through high magnetic permeable materials 86 on platform 80. High magnetic permeable posts 84 also guide the generated magnetic field or flux to magnetic poles on disposable substrate 72. In one embodiment, the magnetic beads can be separated and manipulated on the disposable cartridge 70.

In order to dispense a small drop of fluid desired for assays over a microarray, a micropipette array or system is essential for total biochemical analysis systems with the magnetic array cartridge. Each pipette, which should have an individual dispensing capability, is connected to a reservoir containing a specific buffer solution or other fluid. Furthermore, the dispenser in each pipette has capabilities of both precise measuring and dispensing fluid through the tip of the pipette. The dispensing fluidic volume will be ranged from few pL to few μL.

A few pL of fluid drop has a large surface tension force at the tip of the pipette, which can prevent the dispensing of a droplet onto the desired spot of the array. So, the dispensing system desires to have a pulsation fluidic control to produce a small droplet with a uniform volume. The pulsation fluidic control can be achieved using a microvalve or a microjet pump, which have excellent dynamic characteristics to control enough the desired fluidic droplet for the analysis systems.

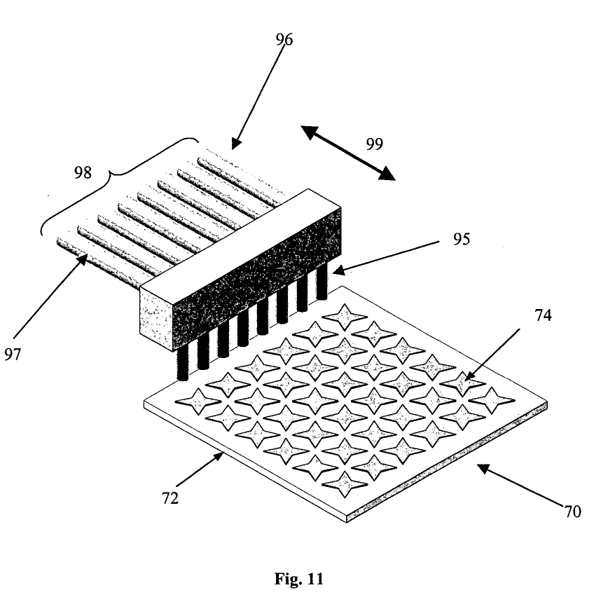

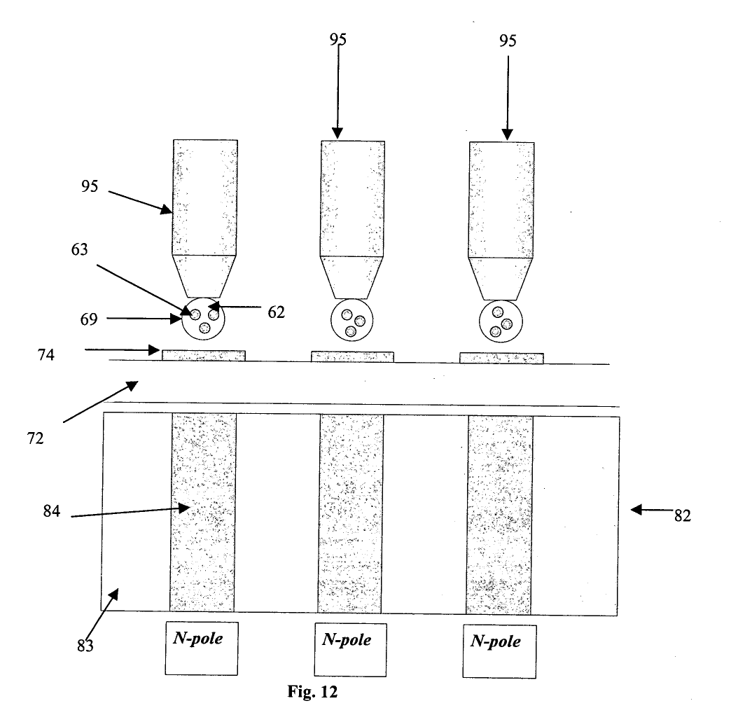

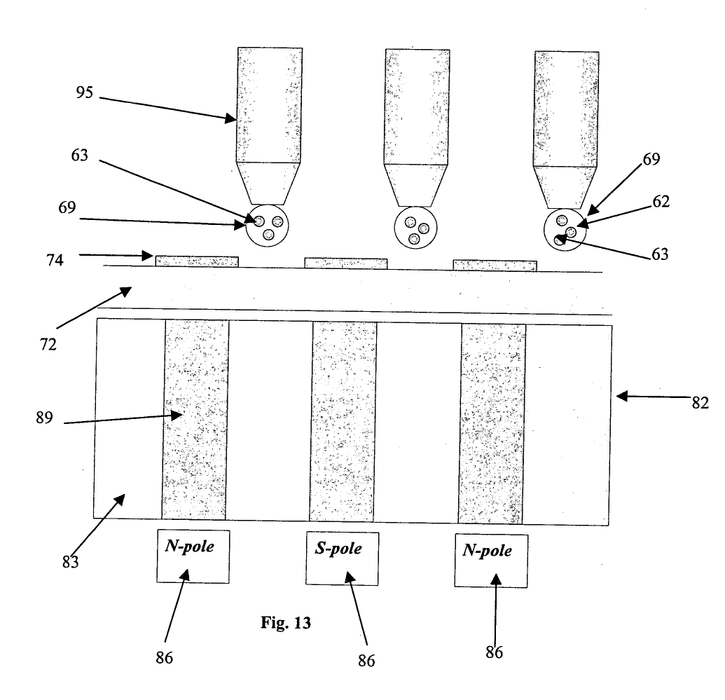

As shown in FIGS. 11 and 12, micropipette array 95 will dispense determined amounts of magnetic bead sample 69 and/or biological sample 104 which will be analyzed. Inner diameter of the micropipette array will generally be from about 0.1 microns to about 100 mm, preferably from about 1 microns to about 10 mm, more preferably from about 10 microns to about 1 mm, depending on the volume of samples. In another embodiment, the micropipette array can be connected to mechanical precision control system like robotic arms and can be positioned in three-dimensional coordinates. The micropipette array is typically connected to polymeric tubes 98 through a connecting block. Samples in a few picoliter to a few microliter by volume will be dispensed either on magnetic poles 74 (in FIG. 12) or between magnetic poles (in FIG. 13). For same polarity of magnetic field as shown in FIG. 12, magnetic beads will be dispensed and separated on the top of the magnetic poles. For the case that both polarities is applied as shown in FIG. 13, magnetic beads will be dispensed and separated on between the magnetic poles.

Furthermore, the dispensing system can handle a magnetic fluid, which is a mixture of magnetic beads and buffer solution in an aqueous format. For quantitative bioanalysis, it is very important and desirable to inject almost same number of magnetic beads on the testing spots of the array in each dispensing. To achieve the desired function of dispensing the magnetic beads, a micro-dispensing system with magnetic field-assist can be used. While the formation of a droplet at the tip of the pipette occurs, magnetic field will be applied between the tip and the spot to be dispensed.

Typically, the magnetic field-assist will be in the range of from about 0.001 T to about 100 T, preferably from about 0.01 T to about 10 T, more preferably from about 0.1 T to about 1 T. The droplet size will be a volume from about 0.01 nanoliter to about 100 microliter, preferably from about 0.1 nanoliter to about 10 microliter, more preferably from about 1 nanoliter to about 1 microliter. Typically, the number of magnetic beads 63 in a droplet 69 will be from a about 0 to about 100000, preferably from a about 0 to about 10000, more preferably from a about 0 to about 1000

So, both the bead density of the aqueous solution and the applied magnetic field density will control the total number of magnetic beads in a formed droplet. The field density will be controlled in two steps: (a) a lower field for the formation of a droplet to control the number of the bead involved and (b) a higher field for assisting dispensing function without changing the format of the droplet while a fluidic pulsation motion occurs for dispensing the droplet on the testing spots.

For the magnetic field-assisted injection, a magnetic core will be coated over the tip of the pipette or the magnetic core can be interconnected to magnetic field if desired. A micropipette will be used for an individual dispensing action, but a linear array or a two-dimensional array will be composed of multiplying a micropipette as desired.

Finally, to construct a total dispensing system, each micropipette 95 is preferably connected into a reservoir via a magnetic valve or a micro jet pump. By controlling the valve or pump concurrently with magnetic field control, the total dispensing system will be fully controlled using a control system.

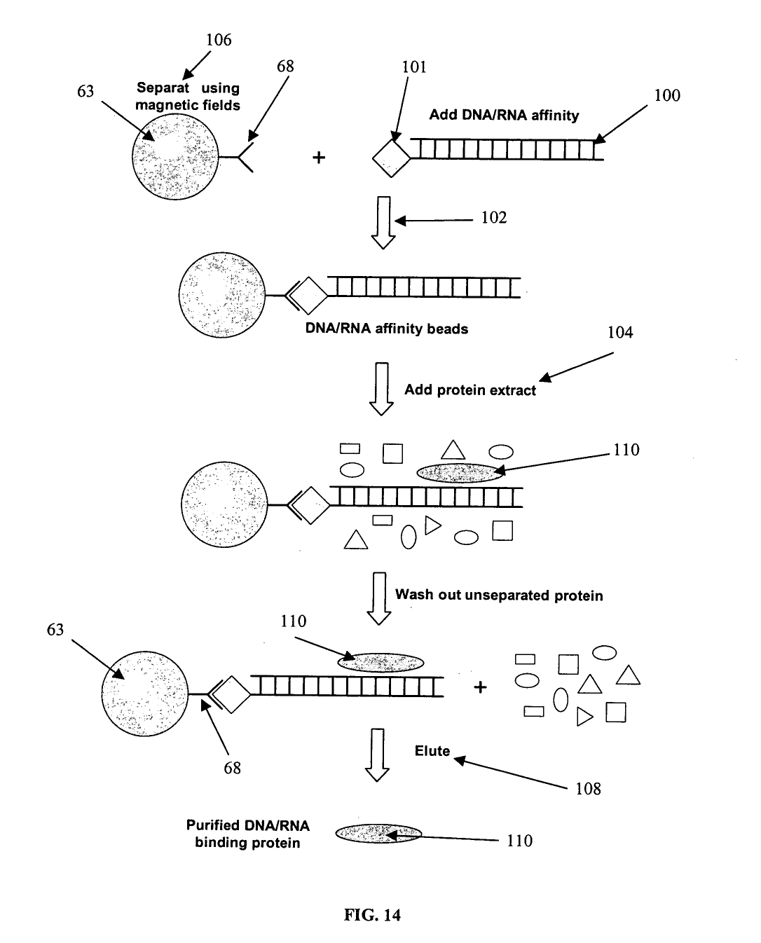

FIG. 14 shows an example of a magnetic bead-based protein analysis. Magnetic beads 63 with biological affinity 68 such as streptavidin or biotin or antibody or DNA/RNA affinity 100 will be dispensed through micropipette array 95 and separated 106. Magnetic beads can also be dispensed and separated as DNA/RNA affinity beads 102. Another or the same micropipette can dispense biological sample 104 onto magnetic beads. The beads capture target proteins or biomolecules 110 that can then be analyzed, detected or purified. By washing out unseparated proteins or biomolecules, only a target protein or biomolecule will be purified for further analysis or treatment or detection.

Although the present invention has been discussed with respect to the preferred and alternative embodiments, it will be apparent to those skilled in the art that the present invention is not limited to these embodiments. Therefore, a person of ordinary skill in the art will understand that variations and modifications of the present invention are within the spirit and scope of the present invention.

1 A micromachined device for collecting target particles comprising:
a) a body structure comprising a substrate; and
b) an array comprising a plurality of permanent magnets deposited on at least one surface of the substrate.

2 The device of claim 1, wherein the body structure comprising an aggregation of two or more layers.

3 The device of claims 1 or 2, wherein the substrate comprises one or more materials selected from the group of glass, silicon, metal and polymeric substrates.

4 The device of claim 3, wherein the body structure comprising at least 50% polymeric materials.

5 The device of claim 4, wherein the polymeric material is selected from the group consisting of wherein the polymeric material is selected from the group consisting of polyamide, polyester, cellulose esters, polyethylene, polypropylene, poly(vinyl chloride), poly(vinylidene fluoride), polyphenylsulfones, polytetrafluoroethylene. Polymethylmethacrylate, polyetheretherketone, polyamide, polypropylene, polycarbonate, polydimethylsiloxane, polystyrene, polysulfone, and polyurethane.

6 The device of claim 3, wherein the body structure is formed by micromachining.

7 The device of claim 6, wherein the micromachining is by one or more methods selected from the group consisting of photolithography, etching, bonding, laser ablation, LIGA, injection molding and embossing.

8 A device according to claim 7, wherein the body structure is a microchip.

9 The device of claim 7, wherein at least one permanent magnet has a dimension between about 0.1 microns and about 500 microns.

10 The device of claim 7, wherein the magnets of the array have a height of from about 0.01 microns to about 500 microns,

11 The device of claim 7, wherein the magnets of the array have a height of from about 0.1 microns to about 200 microns,

12 The device of claim 7, wherein the magnets of the array have a height of from about 1 microns to about 100 microns,

13 The device of claim 7, wherein the magnets of the array have a height of from about 10 microns to about 50 microns;

14 The device of claim 10, wherein the magnets of the array have a width of from about 0.01 microns to about 500 microns.

15 The device of claim 10, wherein the magnets of the array have a width of from about 0.1 microns to about 200 microns.

16 The device of claim 10, wherein the magnets of the array have a width of from about 1 microns to about 100 microns.

17 The device of claim 10, wherein the magnets of the array have a width of from about 10 microns to about 50 microns.

18 The device of claim 14, wherein the magnets of the array have a gap between magnets of from about 0.01 microns to about 500 microns.

19 The device of claim 14, wherein the magnets of the array have a gap between magnets of from about 0.1 microns to about 200 microns.

20 The device of claim 14, wherein the magnets of the array have a gap between magnets of from about 1 microns to about 100 microns.

21 The device of claim 14, wherein the magnets of the array have a gap between magnets of from about 5 microns to about 50 microns.

22 The device of claim 3, wherein the magnet array is a CoNiMnP-based permanent magnet array.

23 The device of claim 22, wherein the magnet array comprises:
a) from about 50 to about 97% Co;
b) from about 0 to about 40% Ni;
c) from about 0.05 to about 20.0% P; and
d) from about 0 to about 10% Mn.

24 The device of claim 22, wherein the magnet array comprises:
a) from about 60 to about 95% Co;
b) from about 0 to about 30% Ni;
c) from about 0.1 to about 10% P; and
d) from about 0 to about 5% Mn.

25 The device of claim 22, wherein the magnet array comprises:
a) from about 70 to about 90% Co;
b) from about 0 to about 20% Ni;
c) from about 0.5 to about 10% P; and
d) from about 0 to about 5% Mn.

26 The device of claim 22, wherein the permanent magnet array is provided with controlled direction of magnetization.

27 The method of making the device of claim 3, the method comprising the steps of:
a) providing a suitable substrate; and
b) applying a suitable array of permanent magnets to at least one surface of the substrate.

28 The method of claim 27, wherein the array is a CoNiMnP-based permanent magnet array.

29 The method of claim 28, wherein the array is fabricated by a method selected from the group consisting of pattern molding by photolithography, electroplating, and channel filling.

30 The method of claim 29, wherein the array is fabricated by photolithography.

31 The method of claim 29, wherein the array is fabricated by electroplating.

32 The method of claim 31, wherein prior to applying an array to the at least one surface of the substrate there is applied one or more interface layers comprising the layers selected from the group consisting of a seed layer, an adhesion layer, and combinations thereof.

33 The method of claim 32, wherein the seed layer consists of a metal layer comprising at least one metal selected from the group consisting of copper, nickel, gold, silver, platinum and alloys thereof in a thickness of from about 10 to about 25000 angstroms.

34 The method of claim 33, wherein the seed layer is from about 100 to about 10000 angstroms.

35 The method of claim 33, wherein the seed layer is from about 1000 to about 5000 angstroms.

36 The method of claim 33, wherein the adhesion layer is selected from the group consisting of chromium, titanium, and alloys thereof in a thickness from about 10 to about 5000 angstroms.

37 The method of claim 36, wherein the adhesion layer is from about 500 to about 1000 angstroms.

38 The method of claim 36, wherein the adhesion layer is from about 100 to about 500 angstroms.

39 The method of claim 32, wherein the direction of magnetization in the magnet array is controlled by external magnetic field during electroplating along in-plane or out-of-plane axis.

40 The method of claim 29, wherein the channel filling is with a magnetic paste in an array pattern while applying an external magnetic field to the substrate.

41 The method of claim 41, wherein the magnetic paste is prepared from magnetic particles and binding material so as to have the viscosity of from about 10 to about 1000 cP.

42 The method of claim 42, wherein the magnetic particles are selected from the group consisting of Ba-ferrite (BaFe₁₂O₁₉), Sr-ferrite (SrFe₁₂O₁₉), Nd—Fe—B (Nd₁₋₃Fe₁₂₋₁₄B), Sm—Co (SmCo₃₋₉), and alloys and mixtures thereof.

43 The method of claim 42, wherein the binding material is an epoxy resin.

44 The device of claim 22, wherein the device further comprises a second substrate defining a channel or reservoir chamber accommodating colloidal suspensions of cells.

45 The device of claim 44, wherein the device further includes at least one port for introduction of fluid into the chamber.

46 The device of claim 45, wherein the device further includes at least one input port and at least one output port for continuous fluidic operation.

47 The device of claim 22, wherein the device is plastic-based disposable cartridge type chip comprising at least one microfluidic path array; at least one inlet port; wherein the substrate additionally comprises at least one sample handling region in fluid communication with at least the microfluidic path array; and is adapted for mixing and analysis of magnetically labeled target particles.

48 A method of cell separation or sorting comprising the following operation steps; (a) inflow of a mixture of magnetically labeled and unlabelled cells into a device of claims 3, 5, 22, 26, or 47; (b) immobilizing the magnetically labeled cells; (c) washing and removal of the unlabeled cell; and (d) collecting the immobilized labeled cells.

49 A system for collecting biological target particles from a fluid medium, the system comprising:
a) a tag for dispersing in the fluid medium and comprising a magnetically responsive material having at least one binding molecule immobilized upon an exterior surface for binding to the biological particles;
b) a magnetic field generator having a substantially planar surface with a spatially distributed array of magnetic field elements for generating within the fluid medium a magnetic field to establish a flow of biological particles coupled to the tag;
c) a cartridge having a spatially distributed array on a surface of the cartridge of Permalloy structures that will work as magnetic poles for positioning within said flow for collecting the target particles thereon wherein the surface forms a fluid barrier and wherein the cartridge is substantially planar and adapted for placement upon the magnetic field generator;
d) wherein the magnetic field generator is arranged relative to the plate to direct the flow to selected portions of the surface for collecting particles thereon; and
e) a controller for controlling the magnetic field of one or more of the elements in the array to spatially distribute the particles collected thereon and for directing the flow of particles.

50 A system of claim 49 wherein the controller further comprises a microprocessor control interface and an optical monitoring system for selectively moving the magnetic field source means relative to the surface for spatially distributing the particles collected thereon.

51 A system of claim 50 further comprising transfer means, coupled to the cartridge, for withdrawal of the target particles collecting thereon.

52 A system of claim 50 wherein the cartridge further comprises a housing for containing fluids.

53 A system according to claims 49, 50 or 51, wherein the magnetically responsive material comprises one or more materials selected from the group consisting of paramagnetic, superparamagnetic, ferromagnetic, and ferromagnetic materials.

54 A system according to claim 53, wherein the magnetically responsive material is iron oxide-impregnated polymer beads.

55 A system according to claim 49, 50 or 51, wherein the magnetic field generator is a device selected from the group consisting of an electromagnet, an air-cored coil, a wire coil, a straight wire, a conductive microfabricated trace, and a permanent magnet.

56 A system according to claim 55, wherein the magnetic field generator is an inductor connected to a magnetic guidance.

57 A system according to claim 51, wherein the system further comprises a device to remove nonspecifically-bound label particles.

58 A system according to claim 49, 50 or 51, wherein the binding molecules are molecules selected from the group consisting of antibodies, polynucleotides, oligonucleotides, peptides, polypeptides, proteins, receptors, chelators and fragments thereof.

59 A system according to claim 58, wherein the target molecules are selected from the group consisting of antibodies, polynucleotides, oligonucleotides, peptides, polypeptides, proteins, receptors, chelators, polymers, metal ions, low molecular weight organic species, cells, and fragments thereof.

60 A system according to claim 49, 50 or 51 wherein the tag comprises a magnetic bead having at least one selected antibody bound on the exterior bead surface and having a specificity for an epitope on one or more particle subpopulations dispersed within the fluid medium.

61 A system according to claim 60 wherein the tag comprises a selected quantity of the magnetic beads.

62 A method for collecting biological target particles from a fluid medium, the system comprising the steps of:
a) providing a tag comprising a magnetically responsive material having at least one substance immobilized upon an exterior surface for coupling to the biological particles, the tag being dispersed within the fluid medium,
b) applying a magnetic field to the fluid medium to establish a flow of biological particles coupled to the tag,
c) disposing a cartridge having a spatially distributed array of Permalloy structures on a substantially planar surface of the cartridge wherein the array will work as magnetic poles for positioning within said flow for collecting the target particles;

63 A method according to claim 62 comprising the further step of transferring the particles from the surface to a receiver with a spatial distribution of particles substantially similar to the distribution of the particles collected on the surface.

64 A method according to claim 63 wherein the magnetic field is applied by arranging the magnetic field generator relative to the plate to direct the flow to selected portions of the surface for collecting particles thereon.

65 A method according to claim 64 comprising the further step of using a controller for controlling the magnetic field of one or more of the elements in the array to spatially distribute the particles collected thereon and for directing the flow of particles.

66 A method according to claim 65 comprising the further step of transferring the biological particles from the surface of the cartridge to the receiver includes the steps of disposing the receiver proximate to the surface of the cartridge and applying a magnetic force to the biological particles for attracting the biological particles to the receiver thereby transferring the biological particles.

67 A method according to claim 65 wherein the controller further comprises a microprocessor control interface and an optical monitoring system for selectively moving the magnetic field source means relative to the surface for spatially distributing the particles collected thereon.

68 A method according to claim 65 wherein the cartridge further comprises a housing for containing fluids.

69 A method according to claim 65 wherein the magnetically responsive material comprises one or more materials selected from the group consisting of paramagnetic, superparamagnetic, ferromagnetic, and ferromagnetic materials.

70 A method according to claim 69 wherein the magnetically responsive material is iron oxide-impregnated polymer beads.

71 A method according to claim 69 wherein the magnetic field generator is a device selected from the group consisting of an electromagnet, an air-cored coil, a wire coil, a straight wire, a conductive microfabricated trace, and a permanent magnet.

72 A method according to claim 69 wherein the magnetic field generator is an inductor connected to a magnetic guidance.

73 A system according to claim 51, wherein the system further comprises a device to remove nonspecifically-bound label particles.

74 A method according to claim 64 wherein the binding molecules are molecules selected from the group consisting of antibodies, polynucleotides, oligonucleotides, peptides, polypeptides, proteins, receptors, chelators and fragments thereof.

75 A method according to claim 64 wherein the target molecules are selected from the group consisting of antibodies, polynucleotides, oligonucleotides, peptides, polypeptides, proteins, receptors, chelators, polymers, metal ions, low molecular weight organic species, cells, and fragments thereof.

76 A method according to claim 64 wherein the tag comprises a magnetic bead having at least one selected antibody bound on the exterior bead surface and having a specificity for an epitope on one or more particle subpopulations dispersed within the fluid medium.

77 A method according to claim 64 wherein the tag comprises a selected quantity of the magnetic beads.

78 A method according to claim 64 wherein each inductor works independently and can produce magnetic flux at any given point as directed by a programmed controller.

79 A method according to claim 78 wherein the inductors generate magnetic flux that asses along magnetic flux guidances.

80 A method according to claim 79 wherein the magnetic flux guidances are star-shaped quadrapoles on at least one planar surface of the cartridge.

81 A method according to claim 80 wherein the magnetic particles are collected at a point substantially near the point edges of the quadrapoles.

82 A method according to claim 626 wherein the receiver is a micropipette array having individual dispensing capability and having a pulsation fluidic control.

83 A method according to claim 82 wherein the micropipette array is connected to a reservoir containing a specific buffer solution.

84 A method according to claim 83 wherein upon formation of a droplet at the tip of the pipette, a magnetic field is applied proximate to the tip wherein the applied magnetic field density controls the total number of magnetic beads in the droplet.

85 A method according to claim 84 wherein the field density is controlled by a lower field for the formation of a droplet to control the number of the bead involved and a higher field for assisting dispensing the droplet.

86 A method according to claim 85 wherein each micropipette of the array is in fluidic communication with an independent fluid reservoir.
